(19) United States
(12) Patent Application Publication
(10) Pub. No.: US 2024/0317981 A1
(43) Pub. Date: Sep. 26, 2024

(54) LONG-FIBER COMPOSITE MATERIAL FOR SOLAR MODULE

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW)

(21) Appl. No.: 18/327,022

(22) Filed: May 31, 2023

(30) Foreign Application Priority Data
Mar. 25, 2023 (TW) 112111309

(51) Int. Cl. C08L 23/12; C08K 13/02; C08L 77/06

(52) U.S. Cl. CPC C08L 23/12; C08K 13/02; C08L 77/06

(57) ABSTRACT

A long-fiber composite material for a solar module includes: (a) 35 wt % to 55 wt % of plastic masterbatches; (b) 30 wt % to 65 wt % of long glass fibers; (c) 0.1 wt % to 1 wt % of an ultraviolet absorber; and (d) 0.1 wt % to 1 wt % of a light stabilizer. The plastic masterbatches are polypropylene or nylon. A weight ratio of the plastic masterbatches to the long glass fibers ranges between 90:10 and 35:65.

### CROSS-REFERENCE TO RELATED PATENT APPLICATION

This application claims the benefit of priority to Taiwan Patent Application No. 112111309, filed on Mar. 25, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a long-fiber composite material, and more particularly to a long-fiber composite material for a solar module.

### BACKGROUND OF THE DISCLOSURE

In a solar module, a support is mainly used to uphold the structure of a solar panel, and the conventional support is usually made of an aluminum alloy or a stainless steel material. As a result, an overall weight of the support is high, and installation can be difficult. Furthermore, metallic materials (such as the aluminum alloy or the stainless steel) can be easily eroded by rain. This may potentially cause corrosion, such that the service life of the support is shortened.

Therefore, how to manufacture a lightweight solar support with plastic materials through a material formula improvement, so as to solve the problems of the metal support being easily eroded and having a high weight, has become one of the important issues to be solved in this industry.

### SUMMARY OF THE DISCLOSURE

In response to the above-referenced technical inadequacies, the present disclosure provides a long-fiber composite material for a solar module.

In order to solve the above-mentioned problems, one of the technical aspects adopted by the present disclosure is to provide a long-fiber composite material for a solar module, which includes: (a) 35 wt % to 55 wt % of plastic masterbatches; (b) 30 wt % to 65 wt % of long glass fibers; (c) 0.1 wt % to 1 wt % of an ultraviolet absorber; and (d) 0.1 wt % to 1 wt % of a light stabilizer. The plastic masterbatches are polypropylene or nylon. A weight ratio of the plastic masterbatches to the long glass fibers ranges between 90:10 and 35:65.

In one of the possible or preferred embodiments, a content of the ultraviolet absorber ranges between 0.4 wt % and 0.8 wt %.

In one of the possible or preferred embodiments, a content of the light stabilizer ranges between 0.4 wt % and 0.8 wt %.

In one of the possible or preferred embodiments, a density of the long-fiber composite material ranges between 1.12 g/cm³ and 1.56 g/cm³.

In one of the possible or preferred embodiments, a melt flow index of the plastic masterbatches ranges between 0.5 and 30.

In one of the possible or preferred embodiments, a fiber length of the long glass fibers ranges between 5 μm and 25 μm.

In one of the possible or preferred embodiments, the long-fiber composite material further includes 0.5 wt % to 10 wt % of a toughening agent.

In one of the possible or preferred embodiments, the long-fiber composite material further includes 0.5 wt % to 10 wt % of a compatibilizer.

In one of the possible or preferred embodiments, the long-fiber composite material further includes 0.1 wt % to 0.6 wt % of an antioxidant.

In one of the possible or preferred embodiments, the long-fiber composite material further includes 0.1 wt % to 2 wt % of a slip agent.

Therefore, in the long-fiber composite material for the solar module provided by the present disclosure, by virtue of “30 wt % to 65 wt % of long glass fibers” and “a weight ratio of the plastic masterbatches to the long glass fibers ranging between 90:10 and 35:65,” a weight of a solar support can be decreased, and an anti-corrosion property of the solar support can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

A first embodiment of the present disclosure provides a long-fiber composite material for a solar module, which includes: (a) 35 wt % to 55 wt % of plastic masterbatches; (b) 30 wt % to 65 wt % of long glass fibers; (c) 0.1 wt % to 1 wt % of an ultraviolet absorber; and (d) 0.1 wt % to 1 wt % of a light stabilizer. The plastic masterbatches are polypropylene or nylon.

A density of the polypropylene ranges approximately between 0.89 g/cm³ and 0.91 g/cm³. In the present disclosure, the plastic masterbatches are used to produce the long-fiber composite material having a density of between 1.12 g/cm³ and 1.56 g/cm³, so that a weight of a solar support can be decreased as required. Furthermore, the polypropylene is a recyclable plastic material, and is represented by the number 5 of the resin identification coding system developed by the Plastics Industry Association in the United States. As such, the long-fiber composite material of the present disclosure is recyclable.

For example, the polypropylene used in the present disclosure can be a polypropylene homopolymer (PP-H), a polypropylene random copolymer (PP-R), or a polypropylene block copolymer (PP-B). By taking processing properties of the plastic masterbatches into consideration, the selected plastic masterbatches have a melt flow index of between 0.5 and 30. If the melt flow index of the plastic masterbatches is less than 0.5, the plastic masterbatches cannot be easily processed due to poor fluidity. If the melt flow index of the plastic masterbatches is greater than 30, a viscosity of the melted plastic material is small and can cause difficulties in molding and processing.

It should be noted that low stiffness of the plastic masterbatches is not beneficial for the manufacturing of the solar support. In the present disclosure, the long glass fibers are further added to increase the stiffness of the plastic masterbatches. Based on a total weight of the long-fiber composite material, an added amount of the long glass fibers is between 30 wt % and 65 wt %, and is preferably between 30 wt % and 60 wt %. If the added amount of the long glass fibers is less than 30 wt %, the stiffness of the long-fiber composite material is insufficient. If the added amount of the long glass fibers is greater than 65%, impact resistance of the long-fiber composite material is reduced. In order to maintain both the stiffness and the impact resistance of the long-fiber composite material, a weight ratio of the plastic masterbatches to the long glass fibers ranges between 90:10 and 35:65, and preferably ranges between 75:25 and 40:60.

In one embodiment of the present disclosure, a fiber length of the long glass fibers (LGF) ranges between 5 μm and 25 μm. If the fiber length is less than 5 μm, a function of improving the stiffness of the long-fiber composite material cannot be achieved. If the fiber length is greater than 25 μm, dispersity of the long glass fibers in the long-fiber composite material will be affected, thereby negatively affecting molding and processing properties and product performance.

In addition, one characteristic of the polypropylene is low resistance to ultraviolet irradiation. After being exposed to the ultraviolet irradiation for a long period of time, the polypropylene has reduced mechanical performance, which may result in aging, discoloration, cracking, or surface chalking. Hence, 0.1 wt % to 1 wt % of the ultraviolet absorber is added, so that the long-fiber composite material of the present disclosure is suitable for manufacturing the solar support. If an added amount of the ultraviolet absorber is less than 0.1 wt %, surface chalking and loss of strength in the solar support may occur. However, it is a waste of materials when the added amount of the ultraviolet absorber is greater than 1 wt %.

For example, the ultraviolet absorber of the present disclosure can be one or more selected from phenyl salicylate, 2-hydroxy-4-methoxybenzophenone, 2,4-dihydroxybenzophenone, m-phenylene dibenzoate, 2-(2′-hydroxy-3′,5′-di-tert-butylphenyl)-5-chlorobenzotriazole, 2-hydroxy-4-octyloxybenzophenone, 2-(2′-hydroxy-5′-methyl-phenyl)benzotriazole, hydroxyphenyl triazine, and 2-(2′-hydroxy-3′,5′-bis(alpha, alpha-dimethylbenzyl)phenyl)benzotriazole. Preferably, the ultraviolet absorber is CYASORBR UV-531 produced by Cytec Industries, Inc.

Moreover, the ultraviolet absorber of the present disclosure is used in combination with the light stabilizer, so as to have a good light-stabilizing effect and reduce damages of the long-fiber composite material caused by sunlight. Specifically, in order to achieve an improved light-stabilizing effect, the long-fiber composite material of the present disclosure includes 0.1 wt % to 1 wt % of the light stabilizer. If an added amount of the light stabilizer is less than 0.1 wt %, surface chalking and loss of strength in the solar support may occur. However, it is a waste of materials when the added amount of the light stabilizer is greater than 1 wt %.

For example, the light stabilizer of the present disclosure can be one or more selected from 2,2′-thiobis(4-tert-octylphenoloxy)nickel, 2,4,6-tris(2′butoxyphenyl)-1,3,5-triazine, tris(1,2,2,6,6-pentamethyl-piperidyl)phosphite, a polymer of succinic acid and 4-hydroxy-2,2,6,6-tetramethyl-1-piperidinol, hexamethylphosphoric triamide, bis(2,2,6,6-tetramethyl-piperidyl)sebacate, bis(2,2,6,6-tetramethyl-4-piperidyl)sebacate, and a hindered benzoic acid ester. Preferably, the light stabilizer is CHIMASSORBR 2020 produced by BASF.

In one embodiment of the present disclosure, the long-fiber composite material further includes 0.5 wt % to 10 wt % of a toughening agent, so as to enhance its impact strength. If the toughening agent of the long-fiber composite material is less than 0.5 wt %, the impact strength of the long-fiber composite material will not be sufficient. If the toughening agent of the long-fiber composite material is greater than 10 wt %, a tensile and bending strength will be decreased.

For example, the toughening agent can be a polyolefin elastomer (POE), which is a polyolefin-like material copolymerized from ethylene and propylene or other α-olefins (e.g., 1-butylene, 1-hexene, and 1-octene). Compared with polyolefin plastics, the polyolefin elastomer has a higher content of comonomers in its molecular chain and a lower density, and is thus suitable for manufacturing a lightweight solar support.

The polyolefin elastomer mainly includes an ethylene propylene copolymer and an ethylene/α-olefin copolymer. An ethylene propylene copolymer elastomer includes an ethylene-propylene rubber (EPM) and an ethylene-propylene-diene monomer (EPDM) rubber. An ethylene/α-olefin copolymer elastomer mainly includes an ethylene/α-olefin random copolymer and an ethylene/α-olefin block copolymer (OBC).

In one embodiment of the present disclosure, the long-fiber composite material further includes 0.5 wt % to 10 wt % of a compatibilizer. If the compatibilizer of the long-fiber composite material is less than 0.5 wt %, physical mechanical performance will be reduced due to insufficient compatibility. If the compatibilizer of the long-fiber composite material is greater than 10 wt %, a heat-resistant temperature and an extrusion processability of a plastic alloy will be reduced.

For example, the compatibilizer can be an ethylene-propylene-diene monomer grafted with glycidyl methacrylate (EPDM-g-GMA or EPDM-GMA), poly(ethylene octene) grafted with glycidyl methacrylate (POE-g-GMA or POE-GMA), an ethylene-propylene-diene monomer (EPDM), a styrene-butadiene-styrene (SBS) copolymer, a styrene-ethylene-butylene-styrene (SEBS) copolymer, a polyolefin elastomer (POE), or a polyolefin elastomer grafted with maleic anhydride (POE-g-MA or POE-MA).

In one embodiment of the present disclosure, the long-fiber composite material further includes 0.1 wt % to 0.6 wt % of an antioxidant. If the antioxidant of the long-fiber composite material is less than 0.1 wt %, a problem of pyrolysis can occur. However, it is a waste of materials when the antioxidant of the long-fiber composite material is greater than 0.6 wt %. For example, the antioxidant can be one or any combination of pentaerythrityltetrakis (3,5-di-tert-butyl-4-hydroxyphenyl)propionate, tris(2,4-ditert-butylphenyl)phosphite, and octadecyl 3-(3,5-di-tert-butyl-4-hydroxyphenyl)propionate.

In one embodiment of the present disclosure, the long-fiber composite material further includes 0.1 wt % to 2 wt % of a slip agent. If the slip agent of the long-fiber composite material is less than 0.1 wt %, shear heat can be easily generated due to insufficient slipperiness during extrusion processing, which may result in decomposition. If the slip agent of the long-fiber composite material is greater than 2 wt %, precipitation of the slip agent and slipperiness during extrusion may occur. For example, the slip agent is selected from the group consisting of hydrocarbon, fatty acid amide, high fatty acid, esters, alcohols, metal soaps, and composite lubricants. However, the aforementioned examples describe only one of the embodiments of the present disclosure, and the present disclosure is not intended to be limited thereto.

In one embodiment of the present disclosure, through profile extrusion, the long-fiber composite material is used to manufacture the solar support having a size of 6.0 cm (height)×4.2 cm (width) or 2.0 cm (height)×3.0 cm (width). A length of the solar support can be adjusted according to practical requirements.

### Example 1

In Example 1 of the present disclosure, the long-fiber composite material includes 45 wt % of the plastic masterbatches, 50 wt % of the long glass fibers, 1 wt % of the ultraviolet absorber, 0.5 wt % of the light stabilizer, 1 wt % of the toughening agent, 1 wt % of the compatibilizer, 0.5 wt % of the antioxidant, and 1 wt % of the slip agent. Through the profile extrusion, the solar support having the size of 6.0 cm (height)×4.2 cm (width) is manufactured.

### Comparative Example 1-1

The long-fiber composite material adopted in this example is the same as that of Example 1, and the solar support having the size of 2.0 cm (height)×3.0 cm (width) is manufactured through the profile extrusion.

### Comparative Example 1-2

6061-T6 aluminum alloy is adopted to manufacture the solar support having the size of 2.0 cm (height)×3.0 cm (width).

### Modeling Analysis of Mold Flow Software

In the present disclosure, a strain evaluation is performed on Example 1 and Comparative Examples 1-1, 1-2 through a modeling analysis of a mold flow software, so as to enhance credibility of a product design. Here, a yield strength represents toughness of a material, and is defined as a stress value where a ductile material breaks under a slight increase of a force that exceeds an elastic limit and causes repeated changes of a stress-strain ratio. The long-fiber composite material is a stiff material, and does not have the yield strength. A fracture strength refers to a ratio of a tensile force when the material fractures to an area of a fractured cross section, i.e., a stress. An elongation rate refers to a ratio percentage between a total deformation of a gauge section after a sample is stretched and fractures and an original gauge length. The Young's modulus is used to measure stiffness of an isotropic elastomer, which is defined as a ratio of a uniaxial stress to a uniaxial deformation within an applicable range of the Hooke's law. The material will deform when being stretched or subject to a compressive force, and its ratio of a transverse strain to a longitudinal strain is the Poisson's ratio. A maximum torque refers to a maximum force applied to a support (i.e., a force that the support withstands during simulation of a force 17 of the Beaufort wind force scale). A maximum stress refers to a stress that the support can withstand. Experimental results are as shown in Table 1.

TABLE 1

| | | | Comparative | Comparative |
|---|---|---|---|---|
| | | Example 1 | Example 1-1 | Example 1-2 |
| Physical | Density (g/cm³) | 1.21 | 1.21 | 2.71 |
| properties | Yield strength | — | — | 259 |
| of a | (MPa) | | | |
| support | Fracture strength | 100 | 100 | 313 |
| material | (MPa) | | | |
| | Elongation rate | 2 | 2 | 12 |
| | (%) | | | |
| | Young's modulus | 8 | 8 | 68.3 |
| | (GPa) | | | |
| | Poisson's ratio | 0.4 | 0.4 | 0.33 |
| Simulation | Cross-sectional | 4.69 | 2.88 | 2.88 |
| test of a | area (cm²) | | | |
| support | Maximum torque | 150,000 | 150,000 | 15,000 |
| | (mm * N) | | | |
| | Maximum stress | 100.91 | 289.69 | 253.42 |
| | (MPa) | | | |
| | Elongation rate | 1.3 | 3.6 | 0.5 |
| | (%) | | | |
| | Failure analysis | Pass | Fail | Pass |
| | Weight (Kg/m) | 0.57 | 0.35 | 0.78 |
| | Costs (NT | 57 | — | 158 |
| | dollar/meter) | | | |

In a failure analysis, if the maximum stress of the support is greater than the fracture strength of the material itself, the support is determined to fail. For example, since the maximum stress of the support in Comparative Example 1-1 is 286.69 MPa, and is greater than a material fracture strength of 100 MPa, such a support is determined as not passing the failure analysis. In comparison, the support in Example 1 has a stress of 100.91 MPa, which is close to the material facture strength of 100 MPa, and is thus determined as passing the failure analysis. The support in Comparative Example 1-2 has a stress of 253.42 MPa, which is less than its material fracture strength of 313 MPa, and is thus determined as passing the failure analysis. Although the fracture strength, the elongation rate, and the Young's modulus of the long-fiber composite material are lower than those of the aluminum alloy, during a simulation test of the support, the long-fiber composite material can still satisfy requirements of being used as the solar support through a structural improvement (as shown from the results of Table 1).

### Weather Resistance Test

Methods that are generally adopted to check weather resistance of plastics include natural exposure and artificially accelerated testing. Since the method of natural exposure is direct exposure in an outdoor environment, such a method is time-consuming, and has low reproducibility due to being affected by environmental factors. Therefore, artificial aging testing is mainly used to test weatherability of the material, and a most common method is photoaging testing. After being irradiated by ultraviolet light for a long period of time, plastics and rubber products of polypropylene (PP) and low-density polyethylene (LDPE) are likely to undergo plastic aging, such as brittleness, discoloration, and poor elasticity. However, metals are not subject to these conditions.

In the present disclosure, different materials are used to manufacture the solar support having a size of 30 mm (height)×30 mm (width)×2.0 mm (thickness), and weather resistance testing is performed for comparison purposes. In an experimental process, irradiation is carried out for 4,000 hours using an ultraviolet B (UVB) light source (which has a wavelength of 313 nm), and a mechanical strength is measured at 0 hours, 1,200 hours, 2,400 hours, 3,000 hours, and 4,000 hours. A maintenance rate is also calculated. Experimental materials and results are as shown in Table 2.

TABLE 2

| | | Maintenance of Tensile | | | | |
|---|---|---|---|---|---|---|
| | | Strength (MPa, %, Hour) | | | | |
| Example | Material | 0 | 1,200 | 2,400 | 3,000 | 4,000 |
| 2-1 | pure material | 25 | 8/31% | — | — | — |
| | of HDPE-8041 | | | | | |
| 2-2 | pure material | 34 | 7/22% | — | | |
| | of PP-K1101 | | | | | |
| 2-3 | LFT-PE (20% | 59 | 39/66% | 34/58% | — | — |
| | LGF) | | | | | |
| 2-4 | LFT-PP (15% | 83 | 67/81% | 66/80% | — | — |
| | LGF) | | | | | |
| 2-5 | LFT-PE-UV | 82 | 87/106% | 100/122% | 87/106% | — |
| | (60% LGF + | | | | | |
| | 0.5% | | | | | |
| | ultraviolet | | | | | |
| | absorber) | | | | | |
| 2-6 | LFT-PP-UV | 101 | 98/98% | 93/93% | 94/94% | 93/92% |
| | (50% LGF + | | | | | |
| | 0.5% | | | | | |
| | ultraviolet | | | | | |
| | absorber) | | | | | |
| 2-7 | SMC (23.5% | 110 | 104/95% | 101/92% | 96/87% | — |
| | short glass | | | | | |
| | fibers for | | | | | |
| | reinforcement) | | | | | |

*SMC (sheet molding compound): a sheet molding material of glass-fiber reinforced thermosetting plastics.

As shown in Table 2, pure polyethylene (PE) is adopted in Example 2-1, and pure polypropylene (PP) is adopted in Example 2-2. After being irradiated by the ultraviolet light for 1,200 hours, a tensile strength of Example 2-1 and that of Example 2-2 are respectively reduced to 31% and 22% of their original values measured at 0 hours. This shows that the polypropylene (PP) and the polyethylene (PE) have poor weather resistance when not being added with the ultraviolet absorber. It can be seen from Example 2-3 and Example 2-4 that the polypropylene (PP) has a better weather resistance effect than the polyethylene (PE) when both are added with the long glass fibers for reinforcement, and a tensile strength of Example 2-4 can maintain 80% of its original value after being irradiated by the ultraviolet light for 2,400 hours. Furthermore, it can be seen from Example 2-5 and Example 2-6 that the long glass fiber-reinforced PE and the long glass fiber-reinforced PP have an improved weather resistance effect after being added with 0.5% of the ultraviolet absorber. Preferably, the long glass fiber-reinforced PP that is added with 0.5% of the ultraviolet absorber has a tensile strength that is 92% of its original value after being irradiated by the ultraviolet light for 4,000 hours, and is evaluated as being resistant to irradiation of outdoor sunlight for 20 years, thereby satisfying requirements of the solar module.

### Upward Tensile Force Testing

Upward tensile force testing is carried out by using an M8 screw for fastening. Since the material is no longer within an interval of elasticity during a failure process, an initial point of failure cannot be easily identified in a simulation analysis, and a stress analysis can easily be inaccurate. Hence, a strain analysis is adopted as a test method, and a point where a maximum strain occurs is taken as an end point of the experiment. Experimental results are as shown in Table 3.

TABLE 3

| | | | Comparative |
|---|---|---|---|
| | Example 3-1 | Example 3-2 | Example |
| Material | PP-LGF 40 LFT | PP-LGF 40 LFT | 6061-T6 |
| Maximum Strain | 2% | 2% | 17% |
| Diameter of a | 17 mm | 13 mm | 13 mm |
| holder (mm) | | | |
| Maximum | 7,000 | 1,500 | 9,000 |
| upward tensile | | | |
| force (N) | | | |

When a maximum upward tensile force reaches about 7,000 N, the material has a strength that is sufficient for being used as the solar support. As shown in Table 3, the maximum strain of the aluminum alloy in a comparative example occurs when the maximum upward tensile force is 9,000 N. The maximum strain of Example 3-2 occurs when the maximum upward tensile force is 1,500 N. However, after a width is enlarged through a structural improvement, the maximum upward tensile force can reach 7,000 N. It should be noted that, since the density of the long-fiber composite material is low, the weight of the solar support will not be overly increased due to an increase of the width.

### Performance Comparison of Different Materials

A specific tensile strength and a specific flexural modulus refer to a tensile strength and a flexural modulus being correspondingly divided by the density, and represent properties of a unit weight of the material. In a salt spray test of the present disclosure, a standardized solution of 5% sodium chloride (NaCl) is used for simulating a highly corrosive environment. Performance comparison of different materials is as shown in Table 4 below.

TABLE 4

| | | Material | | | | |
|---|---|---|---|---|---|---|
| | | Mg-Al- | T-6061 | SS302 | | 50% |
| | | Zn-based | aluminum | stainless | 50% | LGF |
| Item | Unit | alloy steel | alloy | steel | LGF PP | Nylon 6 |
| Density | g/cm³ | 7.59 | 2.7 | 7.86 | 1.22 | 1.55 |
| Tensile | MPa | 490 | 310 | 275 | 130 | 220 |
| strength | | | | | | |
| Specific | m | 6.46 × 10⁴ | 11.48 × 10⁴ | 3.5 × 10⁴ | 10.66 × 10⁴ | 14.19 × 10⁴ |
| tensile | | | | | | |
| strength | | | | | | |
| Flexural | GPa | 279 | 68.9 | 193 | 10 | 14.5 |
| modulus | | | | | | |
| Specific | m | 36.8 × 10⁶ | 25.5 × 10⁶ | 24.6 × 10⁶ | 8.2 × 10⁶ | 9.35 × 10⁶ |
| flexural | | | | | | |
| modulus | | | | | | |
| Salt spray | — | Poor | Poor | Poor | Good | Good |
| resistance | | | | | | |
| UV | — | Good | Good | Good | Poor | OK |
| irradiation | | | | | | |

* Salt spray resistance is deemed as “good” when satisfying the corrosivity category C3 of the ISO 9223 standard, or is otherwise deemed as “poor”.
* After 4,000 hours of the UV irradiation, the material is evaluated as “good” if the tensile strength can maintain 80% or more of its original value, is evaluated as “OK” if the tensile strength can maintain 50% to 80% of its original value, and is evaluated as “poor” if the tensile strength maintains less than 50% of its original value.

According to results of Table 4, an Mg—Al—Zn-based alloy steel, a T-6061 aluminum alloy, and an SS302 stainless steel have a poor degree of salt spray resistance. Only a 50% LGF PP and a 50% LGF Nylon 6 are not likely to have potential corrosion due to salt in the rain, and a composite of a long-fiber material and the polypropylene is further resistant to the UV irradiation.

### Price Comparison of Different Materials

A reference unit price of long fiber thermoplastics (LFT) is calculated based on a unit price of a cost estimate made in March 2022 and an extrusion yield of 95%.

TABLE 5

| | | Mg-Al- | T-6061 | 50% | 50% |
|---|---|---|---|---|---|
| | | Zn-based | aluminum | LGF | LGF |
| Item | Unit | alloy steel | alloy | PP | Nylon 6 |
| Density | g/cm³ | 7.59 | 2.7 | 1.22 | 1.55 |
| Price per | NT | 35 | 148 | 57.82 | 82.54 |
| weight | dollar/kg³ | | | | |
| Price per | NT | 265.7 | 399.6 | 70.5 | 127.9 |
| volume | dollar/L | | | | |
| Costs for | NT | 4 | 4 | 40.0 | 50.0 |
| molding and | dollar/kg | | | | |
| processing | | | | | |
| Fluorocarbon | NT | 350 | 350 | 0 | 0 |
| treatment | dollar/m² | | | | |
| costs | | | | | |

As shown in Table 5, the 50% LGF PP has a minimum density, which is beneficial for the manufacturing of the lightweight solar support. In addition, due to low raw material costs and no fluorocarbon treatment cost, an environmentally-friendly and cost-effective solar support can thus be manufactured.

### Comparison of Advantages and Disadvantages of Replacing Alloy Steel with LFT

TABLE 6

| | | C-shaped steel | | | | | |
|---|---|---|---|---|---|---|---|
| | | (column and | | | | | |
| | | cross-beam support) | | | Aluminum extrusion | | |
| | | Mg- | | | (module bracket) | | |
| | | Al-Zn- | | 50% | T-6061 | | 50% |
| Comparison | | based | 50% | LGF | aluminum | 50% | LGF |
| Item | Unit | alloy steel | LGF PP | Nylon 6 | alloy | LGF PP | Nylon 6 |
| Material | g/cm³ | 7.59 | 1.22 | 1.55 | 2.7 | 1.22 | 1.55 |
| density | | | | | | | |
| Appearance | cm | 12.5/5 | 29/11.5 | 26/10.5 | 4.0/2.0 | 6.5/3.4 | 6.0/3.0 |
| size | | | | | | | |
| (height/width) | | | | | | | |
| Height | % | — | +132.0 | +108.0 | — | +62.5 | +50.0 |
| comparison | | | | | | | |
| Unit weight | kg/m | 5.89 | 4.97 | 5.28 | 0.761 | 0.955 | 1.043 |
| Unit weight | % | — | −15.6 | −10.4 | — | +25.5 | +37.1 |
| comparison | | | | | | | |
| Material | NT | 206 | 302 | 459 | 113 | 58 | 91 |
| costs | dollar/m | | | | | | |
| Processing | NT | 203 | 199 | 264 | 44 | 38 | 52 |
| and treatment | dollar/m | | | | | | |
| costs | | | | | | | |
| Total unit | NT | 409 | 501 | 723 | 157 | 96 | 143 |
| costs | dollar/m | | | | | | |
| Unit cost | % | — | +22.5 | +76.8 | — | −38.9 | −8.9 |
| comparison | | | | | | | |

As shown in Table 6, a long fiber composite has a low density, thereby allowing the solar support manufactured therefrom to have a low weight. Taking costs into consideration, the composite of the long-fiber material and the polypropylene is more profitable.

### Beneficial Effects of the Embodiments

In conclusion, in the long-fiber composite material for the solar module provided by the present disclosure, by virtue of “30 wt % to 65 wt % of long glass fibers” and “a weight ratio of the plastic masterbatches to the long glass fibers ranging between 90:10 and 35:65,” the weight of the solar support can be decreased, and an anti-corrosion property of the solar support can be improved.

More specifically, in the long-fiber composite material provided by the present disclosure, the plastic material is used instead of metallic materials. As such, there is no fluorocarbon treatment cost, and the environmentally-friendly solar support can be manufactured. The manufacturing costs of the solar support can be further decreased by using the composite of the long-fiber material and the polypropylene.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A long-fiber composite material for a solar module, comprising:
(a) 35 wt % to 55 wt % of plastic masterbatches, wherein the plastic masterbatches are polypropylene or nylon;
(b) 30 wt % to 65 wt % of long glass fibers;
(c) 0.1 wt % to 1 wt % of an ultraviolet absorber; and
(d) 0.1 wt % to 1 wt % of a light stabilizer;
wherein a weight ratio of the plastic masterbatches to the long glass fibers ranges between 90:10 and 35:65.

2. The long-fiber composite material according to claim 1, wherein a content of the ultraviolet absorber ranges between 0.4 wt % and 0.8 wt %.

3. The long-fiber composite material according to claim 1, wherein a content of the light stabilizer ranges between 0.4 wt % and 0.8 wt %.

4. The long-fiber composite material according to claim 1, wherein a density of the long-fiber composite material ranges between 1.12 g/cm³ and 1.56 g/cm³.

5. The long-fiber composite material according to claim 1, wherein a melt flow index of the plastic masterbatches ranges between 0.5 and 30.

6. The long-fiber composite material according to claim 1, wherein a fiber length of the long glass fibers ranges between 5 μm and 25 μm.

7. The long-fiber composite material according to claim 1, further comprising 0.5 wt % to 10 wt % of a toughening agent.

8. The long-fiber composite material according to claim 1, further comprising 0.5 wt % to 10 wt % of a compatibilizer.

9. The long-fiber composite material according to claim 1, further comprising 0.1 wt % to 0.6 wt % of an antioxidant.

10. The long-fiber composite material according to claim 1, further comprising 0.1 wt % to 2 wt % of a slip agent.
